(19) United States
(12) Patent Application Publication
(10) Pub. No.: US 2016/0181839 A1
(43) Pub. Date: Jun. 23, 2016

(54) System and Method for Battery Charging

(71) Applicant: Instavolt Inc., Blainville (CA)

(72) Inventors: Mathieu RACINE, Sainte-Therese (CA); Hossein SAMIMI, Laval (CA)

(21) Appl. No.: 14/885,730

(22) Filed: Oct. 16, 2015

Related U.S. Application Data
(60) Provisional application No. 62/093,905, filed on Dec. 18, 2014.

(51) Int. Cl. H02J 7/00

(52) U.S. Cl. CPC H02J 7/0026; H02J 7/0021; H02J 7/007; H02J 2007/0096

(57) ABSTRACT

A battery charger for use with at least one battery and a method for charging a battery. The battery is selected from one of a rechargeable and a non-rechargeable battery. The battery charger comprises a microcontroller comprises charging circuitry configured to charge the battery, the charging device supplying a charging sequence to the battery, the charging sequence being a pulsed current of a predetermined frequency and a predetermined amplitude, the charging sequence having an active/on portion and a resting/off portion; a monitoring device for monitoring a voltage reading on said at least one battery during each resting/off portion; and a controller configured to stop the charging of the battery charger when the voltage reading exceeds a pre-defined threshold.

This application claims priority to U.S. Provisional Patent Application No. 62/093,905 filed on Dec. 18, 2014, the contents of which are incorporated herein by reference.

### TECHNICAL FIELD

The following generally relates to charging of non-rechargeable and rechargeable batteries.

### BACKGROUND OF INVENTION

Batteries are known to effectively provide electrical energy and have thus greatly facilitated the development of electronic devices. Batteries continue to experience high demand while significant improvements in composition have led to increased battery life, better performance and safer use. Non-rechargeable batteries, or primary cells, are used once before they are discarded. Rechargeable batteries, or secondary cells, can be discharged and recharged multiple times before the battery ceases to be effective. It is known that non-rechargeable batteries are of lower cost to produce and are more convenient to use since they can store more charge. However constantly disposing of and replacing batteries is harmful to the environment and may ultimately cost the consumer more money.

Recharging a non-rechargeable battery has proven difficult to perform due to safety and performance issues. It is known that inserting a non-rechargeable battery in a battery charging device can cause a battery to leak or even explode. Existing battery chargers recharge attached batteries by supplying a constant current. Methods of improving safety, such as determining the amount of current to be supplied or even if the battery can receive a charge, have yet to be included or are disregarded. Additionally, it is known that manufacturers of rechargeable batteries provide battery chargers that can only recharge batteries of the same brand.

Conventional battery chargers are often equipped with a means of communicating with a user. Typically, a light capable of changing color or repetitiously flashing a pattern is used. While a user can be informed of the charging battery status, detailed data is difficult or impossible to infer.

Accordingly, there is a need for a system and method for battery charging that allows charging of non-rechargeable and rechargeable batteries. Therefore, it is one object of the present invention to obviate or mitigate at least some of the above-presented disadvantages.

### SUMMARY

In one aspect, there is provided a battery charger for use with at least one battery, the battery being selected from one of: rechargeable and non-rechargeable battery, the battery charger comprising: a microcontroller comprises charging circuitry configured to charge the battery, the charging device supplying a charging sequence to the battery, the charging sequence being a pulsed current of a predetermined frequency and a predetermined amplitude, the charging sequence having an active/on portion and a resting/off portion; a monitoring device for monitoring a voltage reading on the at least one battery during each resting/off portion; a controller configured to stop the charging of the battery charger when the voltage reading exceeds a pre-defined threshold.

In another aspect, there is provided a method for charging a battery, the method comprising: supplying a charging sequence to the battery using a microcontroller comprising charging circuitry, the charging sequence being a pulsed current of a predetermined frequency and a predetermined amplitude, the charging sequence having an active/on portion and a resting/off portion; monitoring a voltage reading on the at least one battery during each resting/off portion using a monitoring device; and using a controller to stop the charging of the battery charger when the voltage reading exceeds a pre-defined threshold.

### BRIEF DESCRIPTION OF DRAWINGS

FIG. 1 is an example overview of a pulsed current battery charger;

FIG. 2 is an example overview of a microcontroller for a pulsed current battery charger;

FIG. 3a and FIG. 3b illustrate a front view and a side view of a pulsed current battery charger, in accordance with one embodiment;

FIGS. 3c and 3d illustrate an isometric view and a top view of the contact points of the charger in FIGS. 3a and 3b;

FIG. 4 is an example of display of content shown on the display screen of a pulsed current battery charger;

FIG. 5 is an exemplary flow chart illustrating the operation of the pulsed current battery charger of FIG. 1;

FIG. 6 is an exemplary flow chart illustrating computer executable instructions to detect a defective battery and to determine if a charge was received;

FIG. 7 is illustrates exemplary steps for sending of a message from a pulsed current battery charger to an electronic device;

FIG. 8 is an exemplary flow chart illustrating computer executable instructions to determine the display content to be shown on the display screen of a pulsed current battery charger;

FIG. 9 illustrates an example charging sequence of a pulsed current battery charger;

FIG. 10 is an example of the relationship between the charging supply and the battery voltage; and

FIG. 11 is an example flow chart illustrating computer executable instructions to determine a charging sequence.

### DETAILED DESCRIPTION

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It is known in the art that recharging a non-rechargeable battery can be dangerous. Inserting a non-rechargeable battery into a battery recharging device can cause the battery to leak potentially dangerous chemicals, start a fire, or in severe cases, even explode. Although there are many available rechargeable batteries, the accompanying battery chargers only charge batteries of the same brand. This is a further inconvenience to consumers since only batteries of the same brand can be purchased. For example, if brand 1 manufactures primary cell and secondary cell NiMH AA batteries with a nominal voltage of 1.2V, brand 1's battery recharging device can only charge the secondary cell batteries. Other manufacturers (e.g. brand 2, brand 3, etc.) cannot charge any of brand 1's batteries. Therefore a method to charge batteries of any type and brand in a safe and efficient manner is required.

It is also known that using rechargeable batteries is better for the environment and requires fewer purchases of batteries. Fewer batteries are disposed of and less waste is produced with batteries that can be recharged.

It is also known in the art that batteries are composed of different materials and hold a different amount of charge. Nickel-cadmium (NiCd) batteries, nickel-metal hydride (NiMH) batteries, alkaline batteries and lithium-ions batteries are known and are common commercial battery types. Although each technology is proven to effectively provide a charge, some are better at holding a charge and have increased longevity compared to the other battery types. As such, due to the variance in the battery types and the technology used by various brand names, different charging methods are used. Different battery sizes also exist. Common battery sizes are commonly referred to as AA, AAA, AAAA, C, D and 9-volt.

Further to the different battery types and battery sizes, some batteries hold a varying amount of charge. For example, the nominal voltage for most AA alkaline batteries is 1.5V, but the nominal voltage for most AA NiCd and NiMH batteries is 1.2V. As such, in addition to the variance in battery types, various charging techniques are employed to recharge batteries of different sizes and different charge.

Conventional battery chargers only possess a light emitting diode (LED) that blinks or changes color during the charging process. Information can be better conveyed to users through new means. By incorporating new technology into battery chargers, new solutions to monitor and control the charging of batteries as well as to reduce the expenditure of power can be developed. As such, new solutions can extend the life of rechargeable and non-rechargeable batteries beyond its estimated lifespan.

The pulsed current battery charger (PCBC), in accordance with an embodiment of the present invention, facilitates the charging of any type of battery, hence both rechargeable and non-rechargeable batteries of any shape, size, technology and capacity can be charged by the PCBC. In one advantage, the charging process is safer than known methods and does not cause any leakage or damage to the batteries. An integrated microcontroller is used to monitor and detect the health of the batteries. A display screen and an integrated communication interface are used to communicate with an electronic device.

In one aspect, a communication module uses wired or wireless communication to send information to an electronic device. As such, a user can be located away from the PCBC to monitor the charging batteries.

Examples of applicable electronic devices include pagers, cellular phones, cellular smart-phones, wireless organizers, personal digital assistants, personal computers, laptops, handheld wireless communication devices, wirelessly enabled tablet computers, handheld gaming devices, cameras and the like. Such devices will hereinafter be commonly referred to as “user devices” for the sake of clarity. It will however be appreciated that the principles described herein are also suitable to other devices.

System Overview

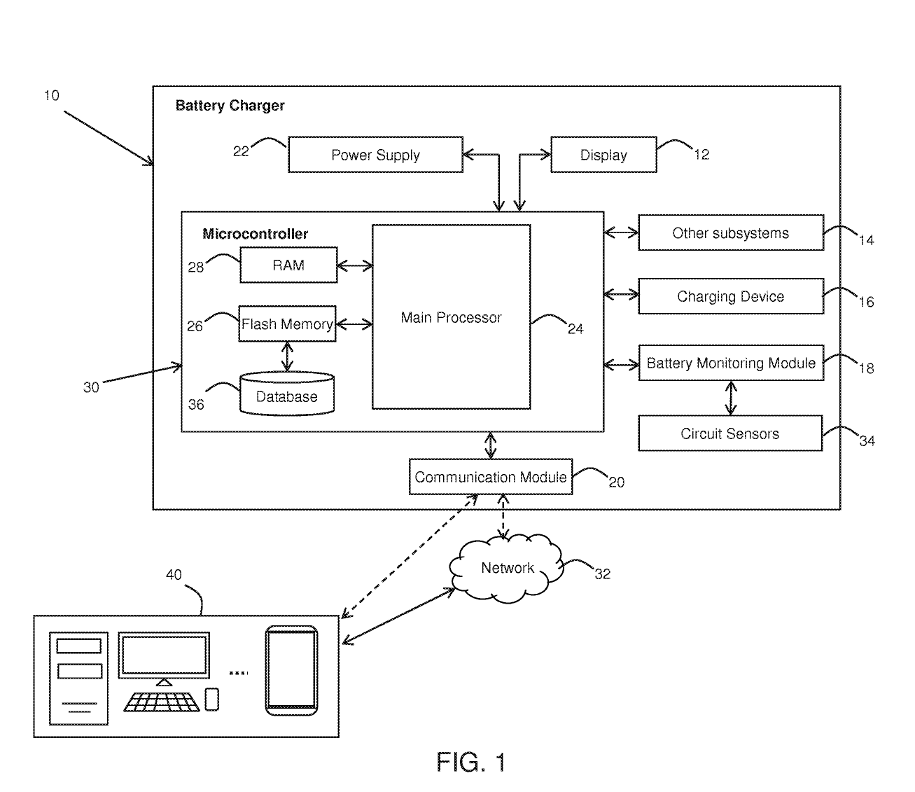

Turning to FIG. 1, the pulsed current battery charger (PCBC 10) is controlled by a microcontroller 30 and includes additional components, comprising a display 12, a charging device 16, a battery monitoring module 18, a communication module 20, a power supply 22, circuit sensors 34 and other suitable device subsystems 14. The microcontroller 30 performs the necessary operations to control and direct the charging of batteries. The power supply 22 provides power to both the microcontroller 30 and the PCBC 10. Preferably, the power supply 22, resides directly on the PCBC 10. The charging device 16 receives input from the microcontroller 30 and includes a compartment to mount batteries as well as the necessary electrical components to charge the batteries. The battery monitoring module 18 is configured for calculating battery health information as well as determining the charge remaining in the batteries. Circuit sensors 34 are coupled to the battery monitoring module 18 and detect physical qualities such as current and voltage, as well as the temperature of the battery. The communication module 20 sends and receives information from the microcontroller to a user device 40. In one embodiment, the communication module 20 and the user device 40 communicate over a network 32. In another embodiment, the communication module 20 communicates directly with the user device 40. Although the communication module 20 has been shown in FIG. 1, as can be envisaged, the battery charger can provide battery charging capabilities as described herein without the communication module 20 present, in one embodiment. Other subsystems 14 can be included on the PCBC 10 and can send information to and from the microcontroller 30. These subsystems can include but are not limited to data ports, speakers, universal serial bus (USB) port, timers, and etc.

The microcontroller 30 includes a main processor 24 that controls the overall operation of the PCBC 10, including the amount of current and the frequency of current pulses provided to mounted batteries. The main processor 24 also interacts with additional subsystems such as a flash memory 26, Random Access Memory (RAM) 28 and a database 36. The operating system and other software components to be executed by the microcontroller 30 are typically stored in a persistent store such as the flash memory 26. Persistent data, as well as data that are frequently accessed such as battery voltage, connected devices, charging sequences, rules and other data, is stored in the database 36 of the flash memory 26. Those skilled in the art can appreciate that data and applications can also be temporarily loaded into a volatile storage medium such as the RAM 28.

Information from the PCBC 10 is shown on the display 12 or is transmitted from the communication module 20 to a user device 40. The information can include, but is not limited to, the amount of time left to fully recharge the battery, the health of the battery, the charge remaining in the battery, and etc. The display 12 can be configured to include any one of known technologies, including liquid-color display (LCD), light-emitting diode (LED) display, organic light-emitting diode (OLED) display, active-matrix organic light-emitting diode (AMOLED) display, or any variants thereof. In one example, the display 12 may be any suitable touch-sensitive display, such as capacitive, resistive, infrared, optical imaging, and other such displays as known in the art. One or more touches may be detected by the touch-sensitive display and the microcontroller 30 may determine attributes of the touch, including a location of a touch. A touch may be detected from any suitable object, such as a finger, thumb, appendage, or other items, for example, a stylus, pen, or another pointer device. In another example, the display 12 may be a non-touch-sensitive display in place of, or in addition to a touch-sensitive display.

The charging device 16 of the PCBC 10 includes at least one compartment for charging at least one battery. If at least two compartments are included, each compartment is operable independent of the other (i.e. two different batteries of different size and/or capacity can be charged by the at least two compartments).

Hardware components, including the mounting fixtures and the electrical components, are included within the charging device 16. It can be appreciated that the mounting fixtures of the charging device 16 can accommodate batteries of any size and shape. For example, AA, AAA or even 9 volt (V) batteries can be mounted on the charging device 16. Additionally, NiCd batteries, NiMH batteries, alkaline batteries, lithium-ions batteries and other batteries, as known in the art, can all be recharged (e.g. simultaneously and/or separately) by the PCBC 10. The same battery charging methods are employed for all of the aforementioned battery types. As such, the PCBC 10 is safe and convenient for charging any battery type, size and shape.

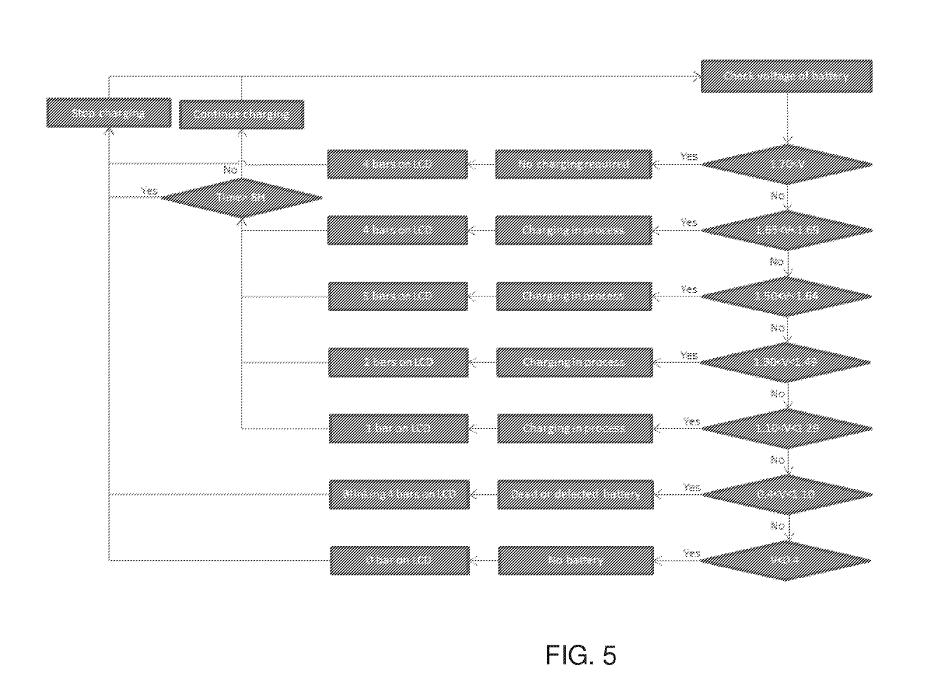

The battery monitoring module 18 operates in conjunction with the microcontroller 30 to detect whether the battery is charging, to protect the battery from overcharging, and to determine the overall health of the battery. For example, the battery monitoring module 18 can detect a defective or dead battery by determining if the battery received a charge. If no charge is received, then the charging process stops to avoid battery damage or leakage and to prevent a possible fire. FIG. 6 illustrates the process of determining a dead or defective battery.

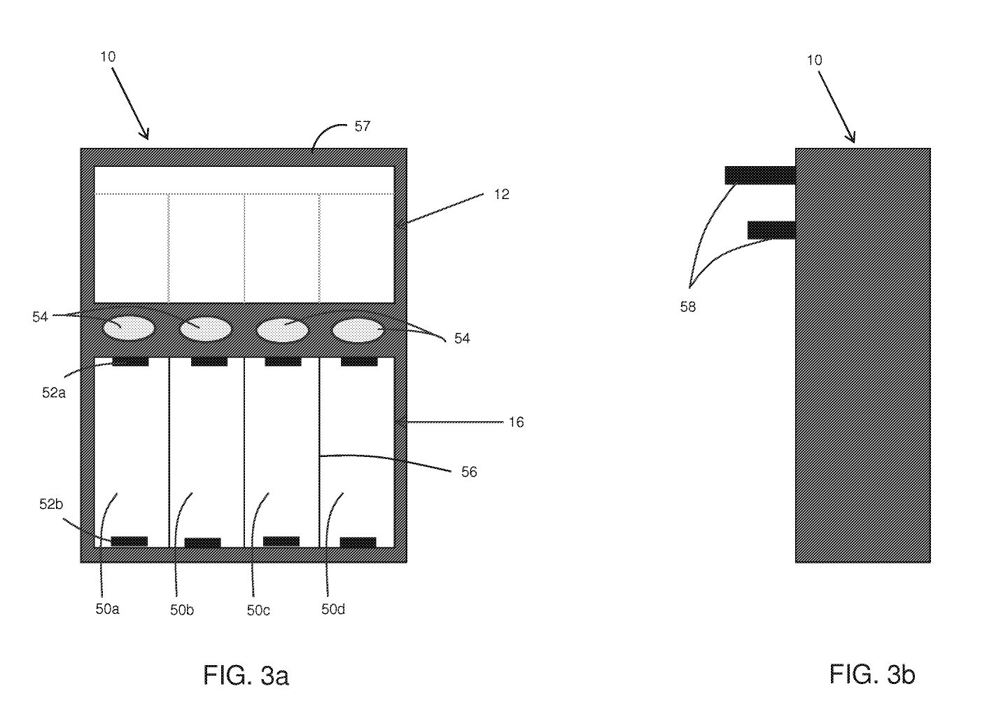

Preferably, the microcontroller 30 is configured for constantly checking the voltage on the battery's connectors (e.g. during the resting cycle of the charging sequence). For example, a battery with an open load voltage lower than 400 mV is considered as no battery connected and thus no bar is shown. If the detected battery voltage is more than 400 mV, then the microcontroller 30 (e.g. in combination with battery monitoring module 18 and/or circuit sensors 34) senses that a battery is inserted. But if the detected voltage is less than a predefined threshold (e.g. 1100 mV) it is considered (e.g. by the battery monitoring module 18) that the battery is poor and thus does not charge the battery for security and safety reasons. That is, no bar is shown on the display screen (e.g. display 12 on FIG. 3a) if a dead battery is connected on the charger 10 (see FIGS. 1 and 3a). If the voltage is over the pre-defined threshold (e.g. 1100 mv), then the microcontroller 30 is configured to start the charging process (e.g. via charging device 16). Once the maximum pre-defined voltage of a battery is reached then the display 12, is configured to visually display when the maximum voltage of the battery is reached (e.g. via the bars on the LCD display blinking). In one example, the LCD display starts blinking when the maximum battery voltage is reached (e.g. at 3 bars depending on the battery being charged).

Thus, in a preferred aspect, the microcontroller 30 is configured for measuring the voltage of a particular battery, it provides a pulse (as described herein and shown in FIG. 6) and then the voltage is measured again. Thus, if the battery is full or broken, the battery charger is configured to stop the charging process. Further, if the battery is capable of receiving another charging pulse, then it the microcontroller 30 is configured to continue the charging process (and constantly detect the charge) until the battery threshold has been reached and the battery is full. A damaged battery won't have any charge detected and thus it will not respond to the microcontroller. In this way, the microcontroller 30 detects a fault with the battery and won't send any further pulses.

In one aspect, the full charge of the battery can also be determined by the battery monitoring module 18. For example, every battery has a maximum voltage capacity, thus when the maximum voltage capacity is reached, the battery charger is configured to stop sending pulses and stop the charging process. It is known to those skilled in the art that batteries degrade over time, and thus battery performance subsequently weakens. Therefore the full charge of the battery, and especially for non-rechargeable batteries, decreases with the number of recharge cycles. In one aspect, the battery monitoring module 18 determines the capacity of the battery. In another aspect, the battery monitoring module 18 is configured to deliver a charge for a pre-determined amount of time (e.g. predefined or preset). In this aspect, if the battery does not fully charge within a predetermined amount of time, then charging still stops according to the pre-determined amount of time. For example, if a AA battery does not fully charge to its expected full-charge value of 1.5V within 8 hours, then a charge is no longer provided to the battery after 8 hours.

The circuit sensors 34 can include temperature, voltage and current sensing sensors that send information to the battery monitoring module 18 accordingly. The sensors comprise a digital thermometer, a voltmeter, an ammeter and other sensors. Battery data, such as the amount of voltage remaining in the battery, and other data, such as the amount of current supplied to the PCBC 10, can be detected by the sensors of the circuit sensors 34. In one example, the data can be coupled with battery monitoring module 18 data before it is reported to the microprocessor 30. The microprocessor 30 is able to interpret the data and communicate with other components.

The communication module 20 of the PCBC 10 is a communication interface that sends information to and receives information from a network 32, or communicates directly with a user device 40. Any one of known wired or wireless communication interfaces can be used by the communication module 20, including short range network systems such as Bluetooth, Wi-Fi, Zigbee, radio frequency (RF) communication, etc. and long range network system such as Global System for Mobile Communication (GSM), General Packet Radio Services (GPRS), Third Generation (3G), Fourth Generation (4G) and Long Term Evolution (LTE). The long range network systems can be used in place of, or in addition to the short range network systems.

It can be appreciated that the user device 40 does not need to be within the immediate vicinity of the communication module 20 for long range systems. In one example, information can be uploaded via Wi-Fi before it is transferred through the network 32 to a user device 40 via LTE. In another example, the PCBC 10 and the user device 40 can be paired through Bluetooth; therefore information can be transferred directly from the communication module 20 of the PCBC 10 to the user device 40 without the need of a network 32. As such, it is apparent to one skilled in the art that any system and any combination of systems can be used for communication purposes.

Microcontroller

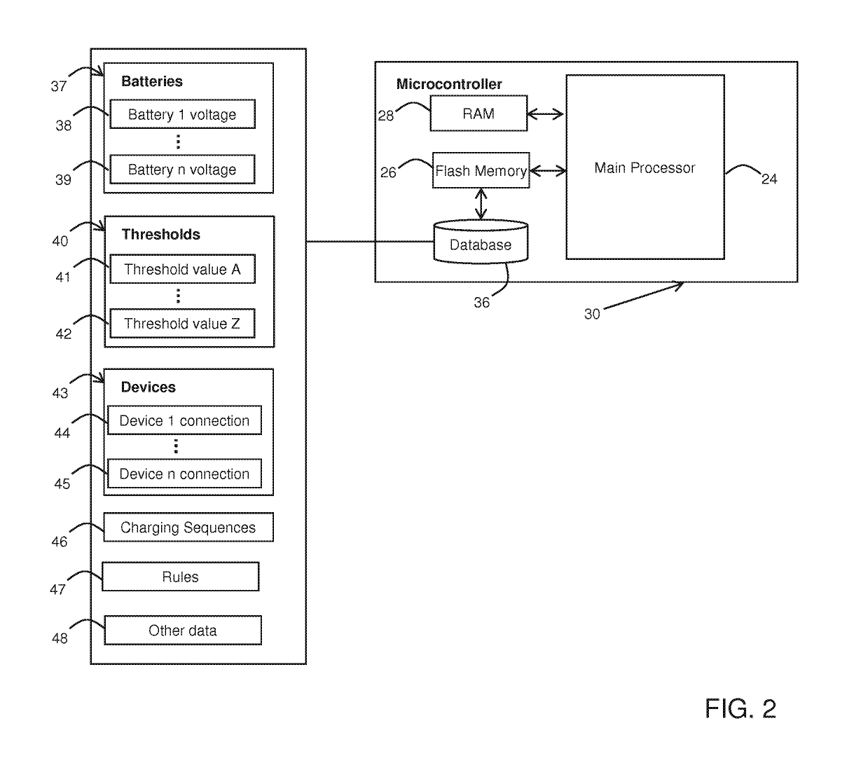

In one embodiment shown in FIG. 2, the microcontroller 30 comprises a main processor 24, flash memory 26, RAM 28 and a database 36. The main processor 24 performs computations while in communication with the other components of the PCBC 10. The RAM 28 facilitates storing data and applications in volatile memory that can be quickly accessed. Frequently accessed data and instructions that should be stored can be kept in a persistent store such as the flash memory 26. A database 36, which stores persistent data comprising battery data 37, threshold values 40, devices 43, charging sequences 46, rules 47 and other data 48, is included in the flash memory 26. Battery data 37 includes for example, the voltage of the connected batteries, comprising battery 1 voltage 37 up to battery n voltage 38. Threshold values 40 include the voltages at which different charging sequences are to be used as well as battery threshold levels to be shown on the display 12. Threshold values comprise threshold value A 39 up to threshold value Z 40. Devices 43 comprise the connection information of device 1 connection 44 up to device n connection 45. Such data can include the connection information to automatically connect the PCBC 10 to a device (e.g. security key or connection frequency) and the type of connection required (e.g. Bluetooth, Wi-Fi). Charging sequences 46 comprise the frequency and amount of current to be supplied to a connected battery. Rules 47 can include, for example, methods of determining the frequency and amount of current to be supplied to a connected battery, safe operating conditions for charging a battery, and when messages are to be delivered to a user device 40. Other data 48 can also be stored in the database 36 and accessed by the main processor 24.

Pulsed Current Battery Charger (PCBC)

It is known in the art that battery chargers are manufactured for the purposes of charging same-brand batteries and it is considered unsafe to charge different branded batteries. It is also considered unsafe to recharge primary cell, or non-rechargeable batteries. Since current battery recharging devices are manufactured specific to batteries of the same brand, the devices are often limited to a specific battery type. For example, if brand 1 manufactures primary cell and secondary cell NiMH AA batteries with a nominal voltage of 1.2V, brand 1's battery recharging device can only charge the secondary cell batteries. Other manufacturers (e.g. brand 2, brand 3, etc.) cannot charge any of brand 1's batteries.

The pulsed current battery charger (PCBC) 10 is shown in FIG. 3. The PCBC 10 is configured to charge batteries of any type and/or brand such as to prevent safety issues. In FIG. 3a, the display 12 is located at the top of the PCBC 10. The display 12 presents information, including the voltage of the battery, the health of the battery, whether the PCBC 10 is connected to a network, and etc., to a user. It can be appreciated that the display 12 can be separated into any number of divisions, or, there can be multiple, separate displays.

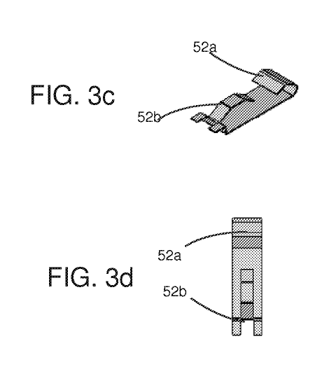

FIG. 4 provides a detailed overview of the display 12. A set of user input devices can be included on the face of the PCBC 10.

### Charging Device

A charging device 16 is included in the PCBC 10 of FIG. 3a. The charging device 16 comprises compartments 50 to hold batteries. Each compartment 50 typically includes two contacts points 52a and 52b that facilitate an electrical connection with a battery. It is common in the art to use a first connection interface 52a and a second connection interface 52b (e.g. both folded nickel plated metal) as contact points. However, it can be appreciated that any method that facilitates an electrical connection can be used. It is common in the art to insert a battery with the positive (+) terminal connected to the first connection interface 52a and the negative terminal (−) connected to the second connection interface 52b.

Referring to FIG. 3c, shown is an isometric view of the battery contact points 52a and 52b. Referring to FIG. 3d, shown is a top view of the battery contact points 52a and 52b as positioned within a particular compartment 50a-50d (e.g. shown in FIG. 3a). As can be seen the connection interfaces are formed of a folded metal (e.g. nickel plated).

The charging device 16 is equipped with the electrical circuitry required to charge primary and secondary cell batteries. Power provided from the power supply 22 is converted to generate a pulsed signal of varying frequency or amplitude.

The compartments 50 of the charging device 16 do not accept batteries inserted backwards and as such do not permit reverse charging. It is known in the art that providing a current to a battery in the direction that discharges the battery instead of charging the battery can result in permanent damage to the battery. Reverse charging can decrease the longevity of a battery and can lead to hazardous results. Preferably, in one embodiment, the microcontroller is configured to detect the orientation of the battery (e.g. via the sensors). After a battery is inserted into a compartment 50 of the charging device 16, a check for battery voltage is made. If the voltage is negative then the battery has been inserted backwards and thus charging will not occur.

Other configurations of the battery compartments for receiving the batteries can be envisaged.

It can be appreciated that the compartments 50 can be dynamic in size and can accommodate batteries of any shape. For example, although the compartments 50a, 50b, 50c and 50d are shown in FIG. 3a as the same size, the compartments 50 can be used to charge AA, AAA, or even 9V batteries. In one embodiment, a user can adjust the size of the compartment 50 by moving at least one linkage bar 56 left or right. In another embodiment, the compartment 50 can be withdrawn from the casing 57 of the PCBC 10. In yet another embodiment, the contact points 52 can be detached from the compartment 50 but remain electrically coupled to the PCBC 10. Those skilled in the art can appreciate that any number of methods that house and facilitate the recharging of batteries of any size can be used by the PCBC 10.

Although the PCBC 10 of FIG. 3a contains four compartments 50a, 50b, 50c and 50d (also collectively referred to as compartments 50), those skilled in the art can appreciate that any number of compartments can be included.

Each compartment 50 of the charging device 16 is operable independent of the other compartments. Each compartment 50 communicates with the microcontroller 30 and two different batteries types and sizes may be recharged at the same time. As such, batteries are monitored and charged separately since the batteries' operating conditions may be quite different.

Power Supply

FIG. 3b is a profile view of the PCBC 10 with components of the power supply 22 shown. In such an embodiment, a set of pronged plugs 58, which can be inserted into a wall outlet, can be seen. The power supply provides the necessary power for the components (e.g. battery monitoring module, circuit sensors, and etc.) included in the PCBC 10 as well as any batteries mounted in the charging device 16. The power supply 22 converts power from the wall outlet using an AC to DC converter. Other components of the power supply 22 can include transformers as well as voltage and current regulators.

Other Subsystems

Although not shown, it can be appreciated that other components can be included on the PCBC 10. The components can include but are not limited to a USB port, speakers, a microphone, other buttons, and etc. The USB port is used to connect an electronic device, such as the user device 40, directly to the PCBC 10 to send and receive messages, and to charge the electronic device. The speakers and microphone are used for output and input mechanisms respectively. For example, when a battery is fully charged the speaker plays a sound. In another example, auditory messages from a user are received by the microphone. Other buttons can be included to, for example, facilitate the connection of the PCBC 10 to a network 32 or to wirelessly connect the PCBC 10 with a user device 40.

Display Screen

The display 12 of the PCBC includes any one of known technologies (e.g. LCD, LED backlight, and etc.). The screen may also be a touch-sensitive screen to receive input from a user. The display 12 receives information from and sends information to the main processor 24 of the microcontroller 30. The information shown on the display 12 typically corresponds to a physical battery that is attached to the charging device 16.

FIG. 4 is an example of battery data content shown on a display 12. The display screen 12 is divided in a first section (64a-b) and a second section 64c. It can be appreciated that the number of first sections corresponds to the number of charging compartments available. In the present example, an image 60a of a battery, which corresponds to a physical battery, is depicted in section 64a. Since the physical battery is fully charged, an image 60a of a completely charged battery with four bars is shown. Although the image is positioned vertically, it can be appreciated that the image can be oriented in any direction (e.g. vertically or horizontally). Similarly, an image 60b of a battery, which corresponds to a physical battery in compartment 50b, is depicted in section 64b. Since the battery is only partially charged, an image 60b of a partially charged battery with three bars is shown. Those skilled in the art can appreciate that this process can repeat for any number of images 60 in a vertical section 64.

Exemplary threshold for each threshold voltages for each bar is provided below. An example battery of 1.7V is used in the example.
0V to 1.09V=no bar
1.10V to 1.29V=1 bar
1.30V to 1.49V=2 bars
1.50V to 1.64V=3 bars
1.65V to 1.70V=4 bars

It can also be appreciated that other information can be shown in the sections 64a and 64b of the display 12. Though not shown, the other information can include the time remaining before full charge, the amount of current supplied to the battery, the charge of the attached battery (in volts), the health status of the battery, and etc. The type of information shown on the display 12 may be toggled automatically (e.g. refreshes after a specified number of seconds), or through an input device.

The second section 64c supplements the information presented in the first section 64a-b. In one example a percentage 62a or 62b is shown. In addition to showing percentages, the second section 64c depicts information such as the connected status of the PCBC 10 (e.g. whether the PCBC is connected to a network or a user device), a warning symbol in case of any possible danger, or any other text that can be conveyed to a user.

Battery Monitoring Module

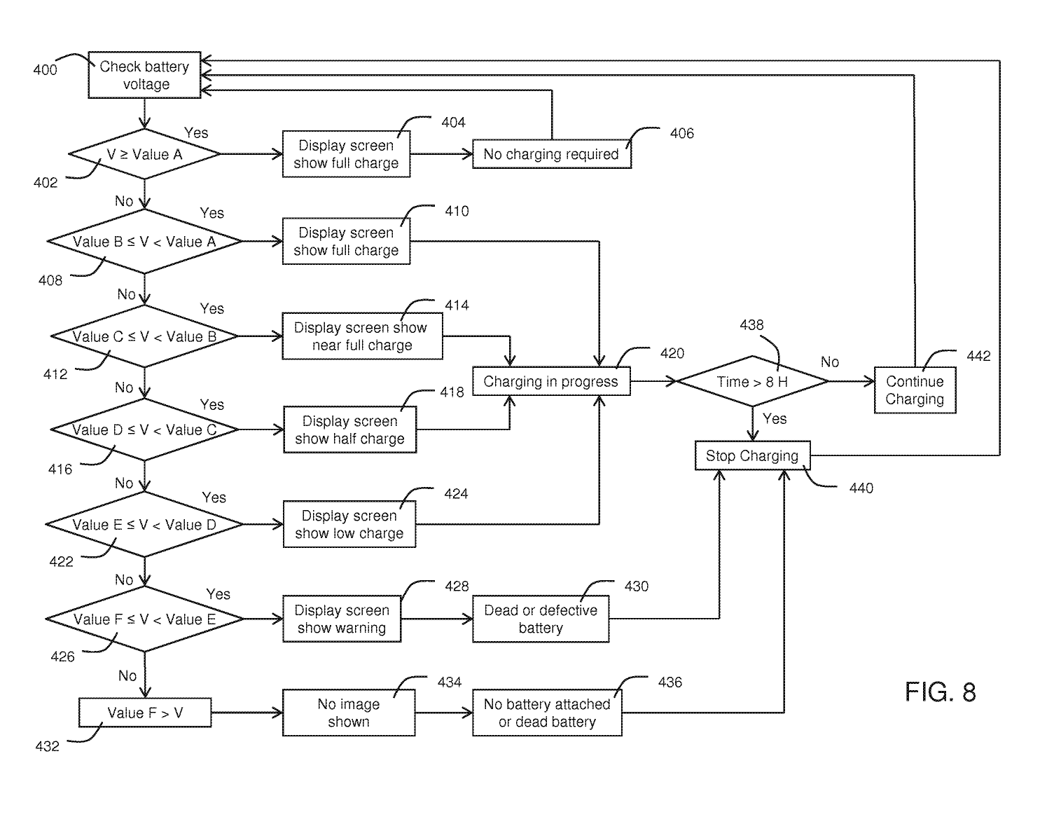

Information displayed on the display 12 is first obtained from the battery monitoring module 18. The battery monitoring module 18 coordinates with the charging device 16 to relay battery information to the microcontroller 30. Attached circuit sensors 34 provide the data to be analyzed. The battery monitoring module 18 detects the health of the batteries and the amount of charge remaining in a battery while ensuring that the PCBC 10 is operating safely with the pre-defined charging sequence (e.g. see FIG. 9) used to recharge the battery. After a battery is mounted in the charging device 16, the battery monitoring module 18 calculates battery and circuit data before sending the data to the microcontroller 30.

The data is obtained from the attached circuit sensors 34, which can include but are not limited to, a voltmeter, an ammeter and a digital thermometer. It is known in the art that a voltmeter measures the electrical potential difference between two points. As such, the voltmeter is used to obtain the voltage of the battery. It is also known in the art that an ammeter measures electric current in a circuit. As such, the ammeter is used to ensure that the proper amount of current is supplied to the battery. The digital thermometer is used to ensure that the battery remains within a safe operating temperature range. For example, an exceedingly hot battery is more likely to cause a fire and is therefore dangerous to users.

FIG. 6 is an exemplary flow chart illustrating computer executable instructions to detect a defective battery and to determine if a charge was received, in accordance with one embodiment of the microcontroller 30 (e.g. shown in FIGS. 1 and 2).

Microcontroller Processing

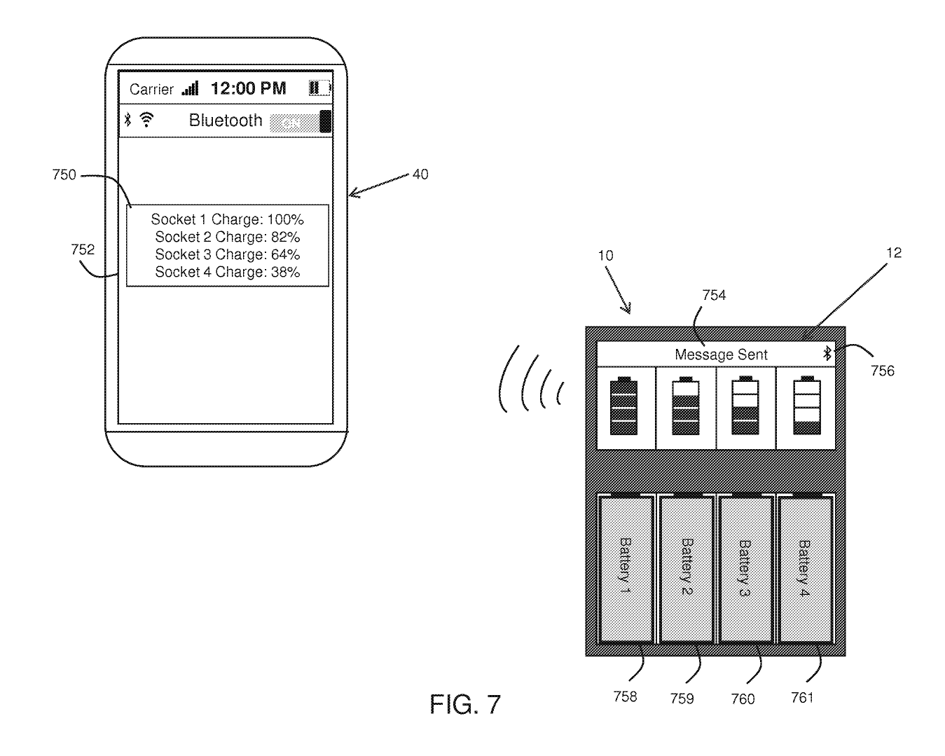

FIG. 8 depicts exemplary computer executable instructions performed by the microcontroller 30 to determine if battery charging is required. If a battery is inserted into the compartment 50 of the charging device 16, then a check for the battery voltage is performed at 400. If the voltage (V) is greater than or equal to a predetermined threshold value A at 402, then the display 12 updates to show the ‘full charge’ image. For example, if an image 60 of a battery is shown, then the image can be updated to be a full battery image, as seen in 60a of FIG. 4. The percentage 62a can also update to correspond to the amount of battery charge. Since the battery is fully charged, at 406 no charging is required and periodic checking of voltage battery continues to be performed at 400. If the voltage was not greater than or equal to predetermined threshold value A, at 408 a check if the voltage is greater than or equal to a predetermined threshold value B but less than A is made. If yes, then the display 12 updates to show a full charge battery image at 410 before the battery continues to charge at 420. If not, then at 412 a check if the voltage is greater than or equal to a predetermined threshold value C but less than B is made. If yes, then the display 12 updates to show a near full charge battery image at 414 before the battery continues to charge at 420. A near full charge battery image, for example, may be a partially charged battery as shown by 60b in FIG. 4. The percentage 62b may also update to correspond to the amount of battery charge. If the voltage was not between the predetermined threshold values at 412, a check if the voltage is greater than or equal to a predetermined threshold value D but less than C is made at 416. If yes, then the display 12 updates to show a half full battery image at 418 before the battery continues to charge at 420. A half full battery image, for example, may be a charging battery as shown by 60c in FIG. 4. The percentage 62c may also update to correspond to the amount of battery charge. If the voltage was not between the predetermined threshold values at 416, a check if the voltage is greater than or equal to a predetermined threshold value E but less than D is made at 422. If yes, then the display 12 updates to show a low battery image at 424 before the battery continues to charge at 420. A low battery image, for example, may be a charging battery as shown by 60d in FIG. 4. The percentage 62d may also update to correspond to the amount of battery charge.

If the voltage was not between the predetermined threshold values at 422, a check if the voltage is greater than or equal to a predetermined threshold value F but less than E is made at 426. If yes, then the display 12 updates to show a warning at 428. A warning, for example, can be an image of a flashing battery or an image of a battery with a warning triangle superimposed. Text can also be used to warn a user. As such, the battery is considered to be either dead or defective at 430 and charging stops at 440. If the voltage was not between the predetermined threshold values at 426, then at 432 the voltage is known to be less than the predetermined threshold value F. As such, at 434 the display 12 does not shown an image since the microcontroller 30 has determined that no battery is attached or the battery is completely dead at 436. The charging stops at 440.

As the battery is charging at 420, a check to determine the total charge time is made at 438. If the charge time for the battery has exceeded a pre-defined time (e.g. 8 hours), then charging stops at 440. If the charge time did not exceed 8 hours, then charging continues at 442. Both 440 and 442 return to 400 to check battery voltage and the process of FIG. 8 continues. It can be appreciated that a battery should preferably complete charging in less than the pre-defined time (e.g. 8 hours). It is considered unsafe and can be damaging to a battery if it is continuously charged for a prolonged period of time beyond the pre-defined time. Thus, in one embodiment, the battery charger 10 as described herein is configured to stop sending any voltage to the battery after a certain period of time or if the battery is full or damaged.

It can be appreciated that the threshold values A, B, C, D, E and F can be obtained both experimentally and from battery characteristics. In one embodiment of the invention, the threshold values are predetermined and are constant. For example, for a standard AA or AAA battery, value A may be 1.70V, value B may be 1.65V, value C may be 1.50V, value D may be 1.30V, value E may be 1.10V and value F may be 0.4V. It can be appreciated that threshold value A usually corresponds to the maximum voltage of the battery, and each subsequent threshold value decreases. In another embodiment of the invention, some of the threshold values may be determined automatically and are dynamically assigned. The total potential charge of the battery is first be detected by the battery monitoring module 18 before the data is sent to the microcontroller 30. The microprocessor 24 then assigns a threshold voltage to the each of the values using an algorithm. For example, the microcontroller 30 detects that the potential charge of the same AA battery has decreased from 1.70V to 1.50V. As such, value A may be 1.50V, value B may be 1.45V, value C may be 1.35V, value D may be 1.20V, value E may be 1.10V and value F may be 0.4V. In the previous example the display 12 would only update to show a near full charge (block 414) if the battery of the current example was fully charged. If the threshold values are determined automatically and are dynamically assigned then the display 12 would show a battery with a full charge (block 404).

It can be appreciated that the threshold values based on pre-defined battery characteristic. Predetermined threshold values corresponding to the battery are obtained from the database 36. The threshold values can be pre-defined and/or automatically determined by the microcontroller 30.

It can also be appreciated that some batteries possess a minimum threshold level, whereby a battery whose voltage is below the threshold will not charge or may only partially recharge. For example, if it is known that NiMH batteries possess a minimum threshold of 1.0-1.1V, further discharge may cause irreversible damage to the battery. In addition to a minimum threshold level, a battery with an open load voltage lower than 400 mV is considered to be the same as no battery connected and as such, the display screen does not shown an image (block 434) of a battery.

Charging Circuitry

It is known in the art that batteries can be charged by forcing an electric current through the battery. In one aspect, the amount of current that is supplied can depend on for example, battery characteristics such as: the type of battery, the size of the battery and how quickly recharging is to occur. The battery characteristics can, in one example be pre-defined and stored on a storage for use by the microcontroller. The PCBC 10 is thus configured to employ a safe and efficient technique to recharge primary or secondary cell batteries. The charging techniques are controlled by the microprocessor 24 of the microcontroller.

In a preferred aspect, both compartments of the battery charger have a same priority for the microcontroller such that the batteries in the compartments are charged at the same time, so that if one of the compartments is empty, the battery located in the other compartment is charged.

FIG. 9 illustrates an example charging sequence of a pulsed current battery charger. The charging sequence 500 as shown in FIG. 9 uses current pulses to charge the batteries. The current pulses comprise a charging current of varying frequency and of varying amplitude. Three current pulses are shown in the charging sequence 500. Those skilled in the art can appreciate that the troughs 502 are resting periods consisting of zero or lower voltage, and the peaks 504 are charging periods consisting of higher voltage. The peaks 504 and troughs 502 are separated by a time of Δt. It can be appreciated that pulsed currents are used to reduce power consumption and to aid in heat dissipation. During resting periods, no current is supplied to the battery and as such, both the PCBC 10 and the attached battery cool. Although pulsed currents may take longer than non-pulsed current to charge a battery, it is safer and facilitates the recharging of primary cell batteries.

In one embodiment of the invention, the charging current is considered to be low amplitude to avoid overheating and overcharging. For example, the charging current may be 200 mA for AA batteries and 100 mA for AAA batteries. In another embodiment of the invention, the frequency of the charging sequence 500 is 4 pulses per second. Each current pulse equates to ⅛ of a second for charging and ⅛ of a second for resting. As such, Δt is found to be: Δt=125 ms. The regularly and most commonly used charging sequence is hereinafter referred to as the “regular charging rate”. During the resting time, a checking sequence 510 performs measurements and calculations (e.g. the voltages of the batteries may be accurately measured, the amount of time left for charging may be obtained, and etc.) to be executed by the microcontroller 30. It can be seen that the checking sequence 810 is of reversed polarity compared to the charging sequence 500. The peaks 514 of the checking sequence 510 correspond to the troughs 502 of the charging sequence 500. Similarly, the troughs 512 of the checking sequence 510 correspond to the peaks 504 of the charging sequence 500. As such, when the charging sequence 500 is not charging the battery, then measurements and calculations are performed. Conversely, when charging is performed the checking sequence 510 is inactive.

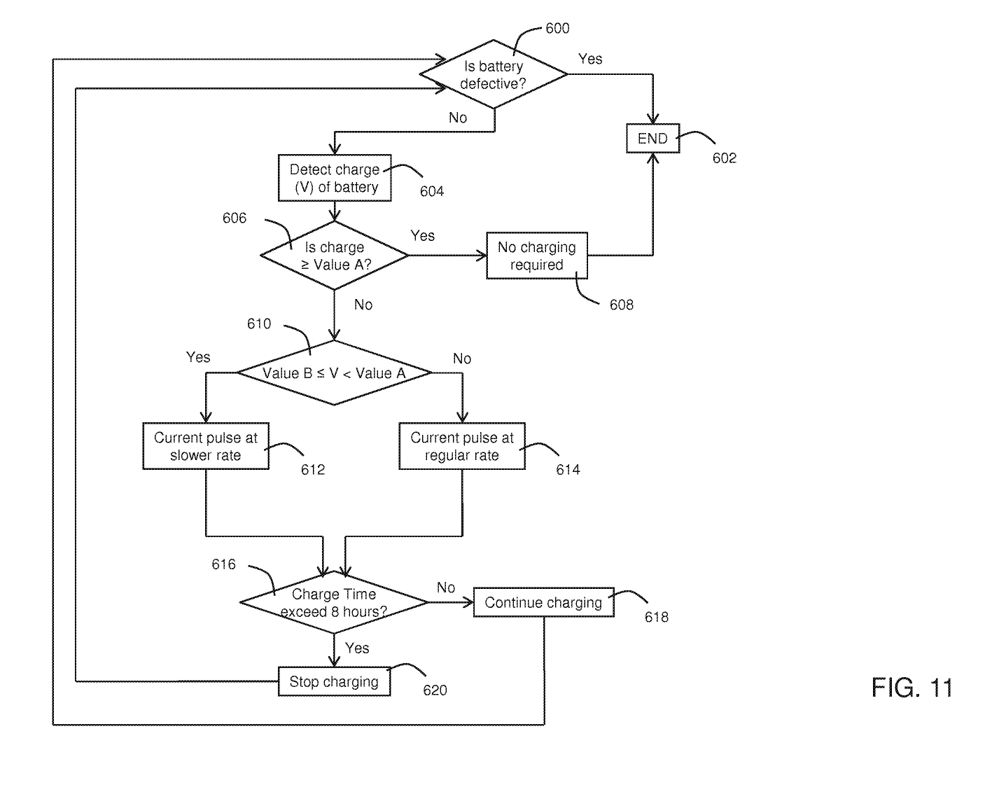

Referring to FIGS. 1 and 11, the battery charger is configured to use computer executable instructions to charge and control voltage of batteries independent of battery type and size. The only difference is that the charging current is pre-defined to be quite low (e.g. 200 mA for “AA” and 100 mA for “AAA”) to avoid overheating or surcharging. This allows a safer charging mechanism.

As illustrated in FIG. 9, the charging circuit is a current pulse charging at 4 pulses per second, ⅛ sec (125 millisecond) charging and ⅛ sec (125 millisecond) resting. During the resting time, battery voltages can be measured accurately by the battery charger 10. When a battery voltage reaches a pre-defined threshold (e.g. 1.65V), current pulses begin to slow down then stop completely on 1.7V.

Accordingly, the current charger 10, is configured such that the charging LED indicators have been replaced by an LCD (e.g. display 12) and connected to a microcontroller 30. The microcontroller 30 is configured to measure the voltages of the batteries under charge and the charge progress can be seen on the LCD. The voltage information is preferably, given in a form of small bar symbols.

The microcontroller 30 and the voltage reading circuitry 34 is preferably located under the power transformer and close to the mains lines which are 120 VAC. Many steps have been taken to prevent interferences, i.e., reading traces are as away as possible from AC traces, filtering is done by RC low pass filters, readings are digitally filtered by averaging algorithms.

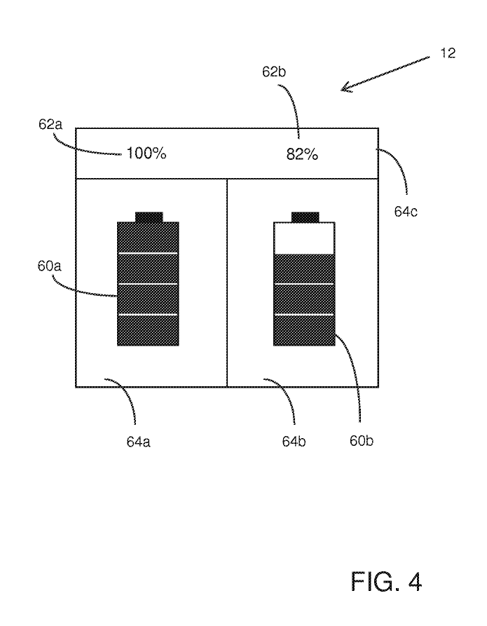

FIG. 5 illustrates the exemplary operation of the battery charger 10, in accordance with one embodiment. In one aspect, a battery with an open load voltage lower than 400 mV is considered as no battery connected and no bar shown. A battery with an open load voltage between 400 mV and 1.1V can be detected but it is too low for charging and all four bars shows as the flashing bars.

Thus, in one aspect, illustrated in FIG. 5 and FIG. 9, the charger 10 (illustrated in FIG. 1) is configured to keep the battery being charged from overloading and thus the charger does not inject voltage continually to the battery, rather it charges the battery as a rectangle pulse with ⅛s charging and ⅛s reading. Thus, each second or other battery receives 4 pulses. The duration of these charging pulses will reduce when the battery reaches 1.65 V and stops when the battery reaches 1.7V. Additionally, in one aspect, the battery charger is further configured to prevent interferences. For example, reading traces are placed as far away as possible from AC traces, filtering is done by RC low pass filters, readings are digitally filtered by averaging algorithms. Thus, these methods are used to avoid any interference from the AC voltages.

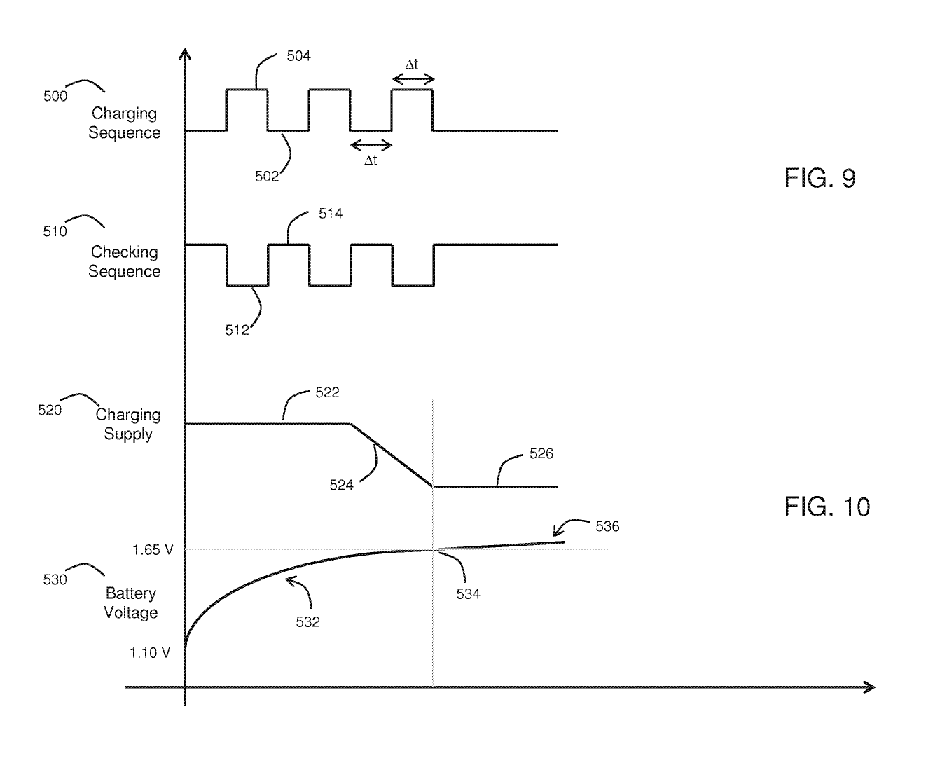

FIG. 10 is an example of charging a battery where two graphs depicting the charging process is shown. The battery of FIG. 10 has a maximum voltage of 1.70V. However, the initial battery voltage 530 is measured and found to be 1.10V. Since the battery is not fully charged, the charging supply 520 is active. Over time, as shown by the curve 532, the battery voltage 530 increases. Similarly, the charging supply 520 remains active as seen by 522. As the battery voltage 530 approaches the threshold value of 1.65V, the charging supply 520 slowly decreases with 524. When the battery voltage 530 reaches the threshold value of 1.65V at 534, then the charging supply 520 has significantly decreased, as shown by 526.

Although the battery is nearly fully charged, it has not obtained its maximum voltage of 1.70V. The charging supply 520 previously used a pulsed current charging sequence of higher amplitude and higher frequency. After a threshold is reached, such as the 1.65V threshold of 534, a slower charging sequence uses a lower amplitude or lower frequency pulse current. It can be appreciated that the slower charging sequence, which operates at a rate slightly faster than trickle charging, still charges the battery but at a lower frequency or lower amplitude than the regular charging rate. Charging stops when the battery has reached its maximum voltage of 1.70V. It can also be appreciated that the charging sequence 500 can increase in amplitude or frequency, thereby charging a battery faster than the regular charging rate.

FIG. 11 is a flow diagram illustrating exemplary steps for the charging sequence as implemented by the battery charger 10. A check is made at 600 to determine if the battery is defective. If yes, then the process ends at 602. If the battery is not defective, the initial charge (in volts, V) of the battery is determined at 604. A check to determine if the charge is greater than threshold value A is made at 606. It can be appreciated that threshold value A can be the same ‘value A’ as FIG. 8. If the charge is greater, then no charging is required at 608 and the process ends at 602. If not, then a second check to determine if the voltage is greater than or equal to a threshold value B but less than threshold value A is made at 610. It can be appreciated that threshold value B can be the same ‘value B’ as FIG. 8. If the battery's voltage is not within the range, then at 614 the current pulses operate at the regular charging rate. If the voltage is within the range, then at 612 the current pulses operate at a slower rate. Following blocks 612 and 614, a check to determine if the charge time has exceeded 8 hours is made at 616. If yes, then the PCBC 10 stops charging at 620. If the charge time has not exceeded 8 hours, then at 618 charging continues. The cyclical process recommences at 600 following blocks 618 and 620.

In one example of FIG. 11, value A can be 1.70V and value B can be 1.65V. It can be appreciated that threshold value A usually corresponds to the maximum voltage of the battery, and threshold value B is a lower voltage. The regular charging rate of block 614 can be the 4 pulse per second current pulse as previously mentioned in FIG. 9 or as shown by line 522 of FIG. 10. As such, each current pulse equates to ⅛ of a second for charging and ⅛ of a second for resting.

Advantageously, this charging method of charging 4 pulses/second, allows charging of any kind of battery and provides the same charging process for each.

The current amplitude can be the current that charges the battery the fastest and most reliably (for example, 100 mA for AAA batteries and 200 mA for AA batteries). The slower rate current pulse of block 612 operates at a rate slightly faster than trickle charging. It can be appreciated that the slower rate current pulses, similar to line 526 of FIG. 10, still recharges the battery.

It can be appreciated that different charging sequences can be associated with different threshold intervals. In the above example, a slower charging sequence can be used when the battery has exceeded a voltage of 1.65V. However faster or slower charging sequences are used for each threshold range. In an example embodiment, a charging sequence of 6 pulses per second can be used for the range of 1.10V to 1.20V; a charging sequence of 5 pulses per second can be used for the range of 1.21V to 1.30V; and etc.

Communication Module

The communication module 20 (e.g. FIG. 1) facilitates two-way communication between the PCBC 10 and a user device 40. Data, such as but not limited to: the amount of charge in a battery, the time remaining before full charge, the health of the battery and etc., may be communicated from the PCBC 10 to the user device 40. Additionally, the user device 40 may communicate instructions, such as start/stop charging, decrease charge time, and etc. to the PCBC 10. In one embodiment, the user device 40 may be connected directly to the PCBC 10 through any wireless or wired means. A wired USB cable, for example, can be used to connect the devices. Wireless modules and communication means can include Bluetooth, Wi-Fi, Zigbee, RF communication, and long range network systems. In some embodiments of the invention, a network 32 (as shown in FIG. 1) may be required to connect the devices.

It can be appreciated that the network 32 can include a medium through which any number of electronic devices may send and receive information. In one embodiment, data is not transferred directly between the user device 40 and PCBC 10, but through a forwarding station. For example, the network 32 may be a shorter range Wi-Fi network where the data must first pass through a router before the data is forwarded to receiving devices. In another example, the network 32 may be a longer range telecommunications network, such as a telephone network, where data must first pass through a cellular tower. It can be appreciated that longer range networks may be used in combination of or in addition to shorter range networks. In another embodiment, the network 32 may be a broadcasting network where any number of devices receives data (e.g. radio). As such, any user device 40 listening at the same frequency receives the data.

The microcontroller 30 coordinates the communication that is executed on the PCBC 10. In one embodiment, a Bluetooth chip may be included in the communication module 20. In another embodiment a Wi-Fi chip may be included in place of or in addition to the Bluetooth chip in the communication module 20. It can therefore be appreciated that any one or combination of hardware apparatuses may be used for communication purposes.

Incoming and outgoing information is first processed by the microprocessor 24 of the microcontroller 30. Data retrieved from the components of the PCBC 10 (e.g. display 12, charging device 16, battery monitoring module 18, circuit sensors 34 and other subsystems 14) are analyzed and packaged before it is relayed to the communication module 20. Incoming information from the communication module 20 is first communicated to the microcontroller 30 for processing before it is communicated to the other components of the PCBC 10. As such, the microcontroller 30 coordinates communication between the user device 40 and the PCBC 10.

Connection to a User Device

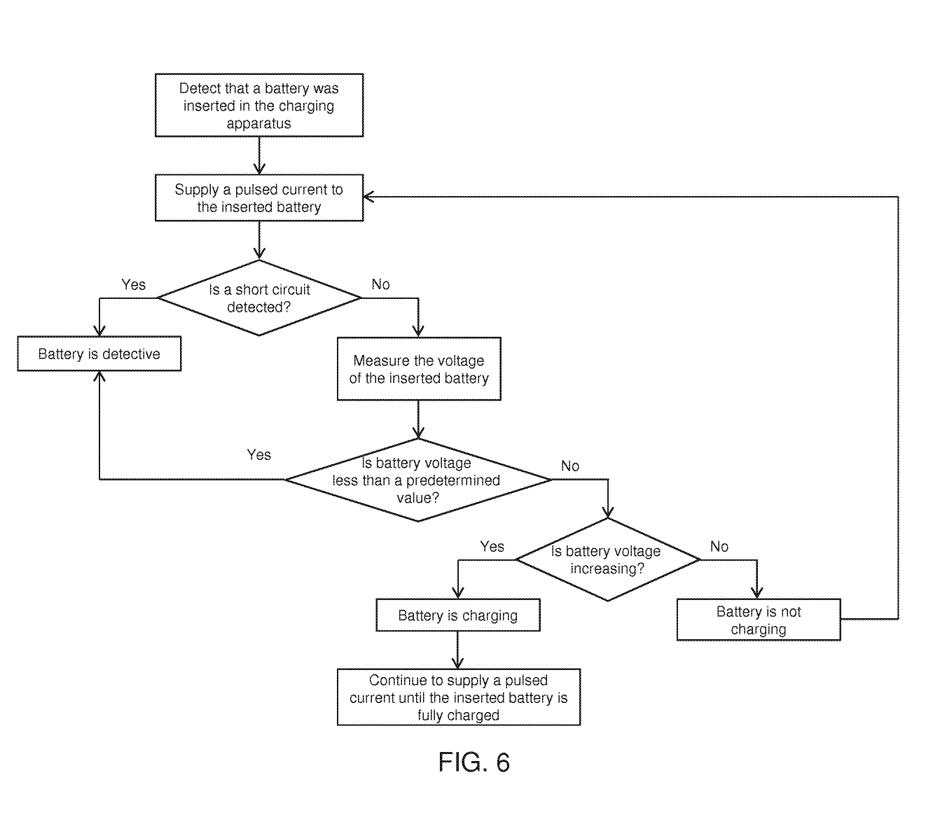

FIG. 7 is an example of a PCBC 10 connected directly to a user device 40 over Bluetooth. A command from the user device 40 instructs the PCBC 10 to report on the status of the batteries. It can be appreciated that the report may also be sent without prompt from a command. For example, the PCBC 10 may be configured to automatically report on the status of the attached batteries every hour. In one embodiment of the example, since the PCBC 10 is connected via Bluetooth to a user device 40, the Bluetooth symbol 756 persists in the corner of the display 12. However, it can be appreciated that any symbol or marker may be used to signify that the PCBC 10 is connected to a network 32 or a user device 40.

The PCBC 10 is charging four batteries 758-761 with socket 1 on the left corresponding to battery 758 and socket 4 on the right corresponding to battery 761. The amount of charge in the batteries 758-761 is shown on the display 12. After sending a message containing battery information, the display 12 updates to display a confirmation 754, such as “Message Sent”. The confirmation 754 may be a textual message, a symbol or a noise produced by the PCBC 10. The message 750 is received by the user device 40 and shown on its display screen 752. The message 750 may include information regarding the charge of the battery. Exemplary text for the message 750 may comprise “Socket 1 Charge: 100%. Socket 2 Charge: 82%” and etc. In another example, the message 750 may also comprise:

BATTERY CHARGER L_2/4 R_3/4 means left battery has 2 bars, right battery has 4 bars

BATTERY CHARGER L_none R_3/4 means no left battery, right battery has 3 bars

BATTERY CHARGER L_low R_1/4 means left battery is too low or defective, right battery has 1 bar

BATTERY CHARGER L_4/4 R_4/4 means both batteries are recharged

It can be seen that after a command was received by the PCBC 10, a response was promptly generated and sent to a user device 40. In some embodiments, the response is a message 750 that reports the status of the batteries. In another embodiment, the response is a confirmation that a command was received. The response may comprise text, pictures, sounds, trigger haptic feedback and any combinations thereof.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A battery charger for use with at least one battery, said battery being selected from one of: rechargeable and non-rechargeable battery, the battery charger comprising:
a microcontroller comprises charging circuitry configured to charge the battery, the charging device supplying a charging sequence to the battery, the charging sequence being a pulsed current of a predetermined frequency and a predetermined amplitude, the charging sequence having an active/on portion and a resting/off portion;
a monitoring device for monitoring a voltage reading on said at least one battery during each resting/off portion;
a controller configured to stop the charging of the battery charger when the voltage reading exceeds a pre-defined threshold.

2. The battery charger of claim 1, further comprising a display configured to display the voltage reading of said at least one battery in the form of bar symbols.

3. The battery charger of claim 1, wherein the pre-determined frequency of the pulsed current is four pulses per second.

4. The battery charger of claim 1, wherein the pulsed current amplitude is 100 mA for AAA batteries and 200 mA for AA batteries.

5. The battery charger of claim 1, wherein the controller is configured to stop charging if the battery is not fully charged after a predetermined amount of time.

6. The battery charger of claim 1, wherein a checking sequence for monitoring the voltage is of a reversed polarity to the charging sequence.

7. The battery charger of claim 1, wherein a database of the controller stores threshold values that can be determined automatically or pre-defined.

8. The battery charger of claim 1, wherein another charging sequence is used after a threshold has been exceeded.

9. The battery charger of claim 1, further comprising a communication module and wherein the battery information, the circuit characteristics and the charging sequence can be communicated to an external electronic device via the communication module.

10. The battery charger of claim 1, wherein the controller is configured to stop the charging process if no charge is received by the at least one battery such as to avoid battery damage or leakage.

11. A method for charging a battery, the method comprising:
supplying a charging sequence to the battery using a microcontroller comprising charging circuitry, the charging sequence being a pulsed current of a predetermined frequency and a predetermined amplitude, the charging sequence having an active/on portion and a resting/off portion;
monitoring a voltage reading on said at least one battery during each resting/off portion using a monitoring device; and
using a controller to stop the charging of the battery charger when the voltage reading exceeds a pre-defined threshold.

12. The method of claim 11, further comprising using a display to display the voltage reading of said at least one battery in the form of bar symbols.

13. The method of claim 11, wherein the pre-determined frequency of the pulsed current is four pulses per second.

14. The method of claim 11, wherein the pulsed current amplitude is 100 mA for AAA batteries and 200 mA for AA batteries.

15. The method of claim 11, wherein the controller is configured to stop charging if the battery is not fully charged after a predetermined amount of time.

16. The method of claim 11, wherein a checking sequence for monitoring the voltage is of a reversed polarity to the charging sequence.

17. The method of claim 11, wherein a database of the controller stores threshold values that can be determined automatically or pre-defined.

18. The method of claim 11, wherein another charging sequence is used after a threshold has been exceeded.

19. The method of claim 11, wherein the battery information, the circuit characteristics and the charging sequence can be communicated to an external electronic device via a communication module.

20. The method of claim 11, wherein the controller is configured to stop the charging process if no charge is received by the at least one battery such as to avoid battery damage or leakage.
